(19) United States
(12) Patent Application Publication
(10) Pub. No.: US 2015/0224033 A1
(43) Pub. Date: Aug. 13, 2015

(54) HEADWEAR CONFIGURED TO ATTACH TO A PACIFIER

(71) Applicant: CORINNA MARIE MOYLAN, Colorado Springs, CO (US)

(72) Inventor: CORINNA MARIE MOYLAN, Colorado Springs, CO (US)

(21) Appl. No.: 14/177,553

(22) Filed: Feb. 11, 2014

(51) Int. Cl. A61J 17/00; A45F 5/02

(52) U.S. Cl. CPC A61J 17/008; A61J 17/001; A45F 5/02

(57) ABSTRACT

Some embodiments of the present invention include a device for aiding a baby in holding a pacifier in its mouth, the device including a piece of headwear, and a first strap and a second strap, each strap having a proximal and a distal end, the proximal end of each of the straps being attached to the headwear such that the straps are spaced from each other, wherein the distal end of each of the straps is configured to attach to in pacifier.

### BACKGROUND

The embodiments herein relate generally to clothing accessories and, more particularly, to headwear capable of attaching to a pacifier.

Newborns, infants, and toddlers often times use a pacifier as a soothing mechanism. However, sometimes a baby is too young to effectively keep the pacifier in its mouth, causing the baby to cry and causing a parent or caretaker to have to repeatedly place the pacifier back into the baby's mouth after the baby has unintentionally spit the pacifier out.

Therefore, what is needed is a system that helps a baby keep a pacifier in its mouth, but still allows the baby to spit the pacifier out when desired.

### SUMMARY

Some embodiments of the present invention include a device for aiding a baby in holding a pacifier in its mouth, the device including a piece of headwear, and a first strap and a second strap, each strap having a proximal and a distal end, the proximal end of each of the straps being attached to the headwear such that the straps are spaced from each other, wherein the distal end of each of the straps is configured to attach to in pacifier.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention in use.

FIG. 2 is an exploded perspective view of one embodiment of the present invention.

FIG. 3 is a detailed elevation view of one embodiment of the present invention, indicated by line 3-3 of FIG. 2.

FIG. 4 is an exploded perspective view of one embodiment of the present invention.

FIG. 5 is a cross-sectional view taken on line 5-5 of FIG. 3.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to attach a pacifier to a piece of headwear and keep the pacifier in place in a user's mouth and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the system.
1. Headwear
2. Straps

The various elements of the device for attaching a pacifier to a piece of headwear and keeping the pacifier in place in a user's mouth may be related in the following exemplary fashion. It is not intended to limit the scope or nature of the relationships between the various elements and the following examples are presented as illustrative examples only.

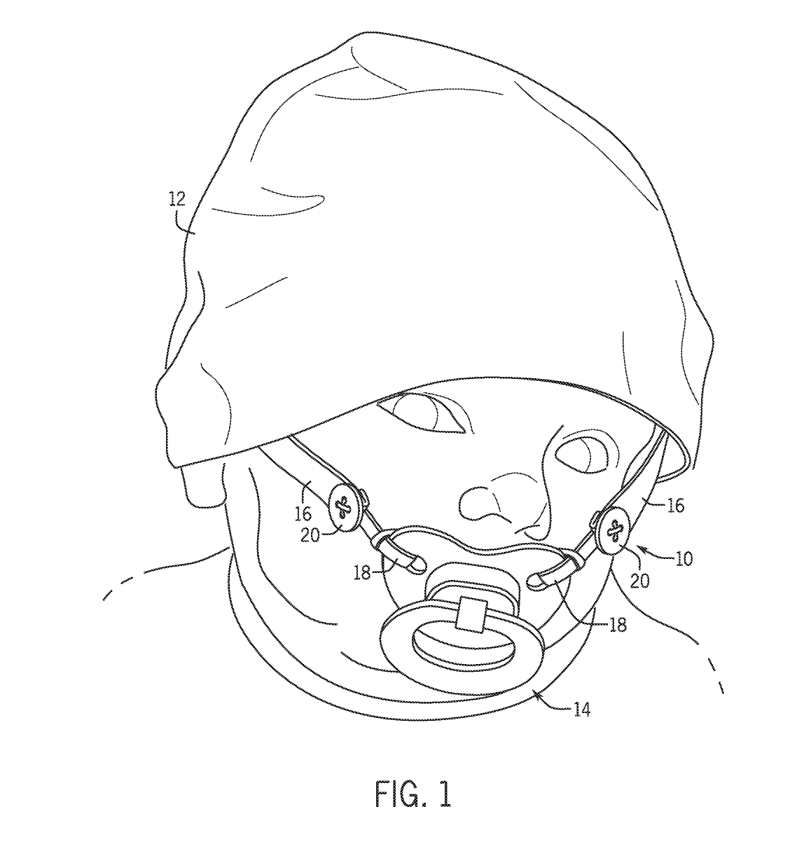

By way of example, and referring to FIG. 1, one embodiment of the present invention 10 comprises a headwear 12 attached to a plurality of straps 16, such as two straps, that are configured to attach to a pacifier 14. For example, in some embodiments, each of the plurality of straps 16 may attach directly to the pacifier 14. In other embodiments, each of the plurality of straps 16 may be attached to a cord 18 that loops through an orifice in a mouth shield of the pacifier 14, as shown in FIG. 1.

Each of the cords 18 may be permanently or removably attached to the straps 16. For example, the cord 18 may be permanently attached to the strap 16 using any conventional means and, in some embodiments, the cord 18 is sewn to the strap 16 or attached to the strap 16 using an adhesive, such as hot glue.

In other embodiments, the cord 18 is removably attached to the strap 16 by any conventional means, such as a button, a snap, or a hook and loop fastener. For example, in some embodiments, the cord 18 has a fastener 20 at a proximal end thereof that is configured to fasten each cord 18 to the corresponding strap 16. The fastener 20 may be any suitable fastener, such as a button, a snap, or Velcro. In embodiments, the cord 18 may also have a loop at a distal end thereof, such that the proximal end of the cord 18 may be fed through an orifice in the mouth shield of a pacifier 14 and then inserted through the loop at the distal end of the cord 18, attaching the cord 18 to the pacifier 14, as shown in FIG. 1. In other embodiments, the cord 18 may be attached to the pacifier using any suitable fastening means, such as a snap, a button, an adhesive, or a hook and loop fastener.

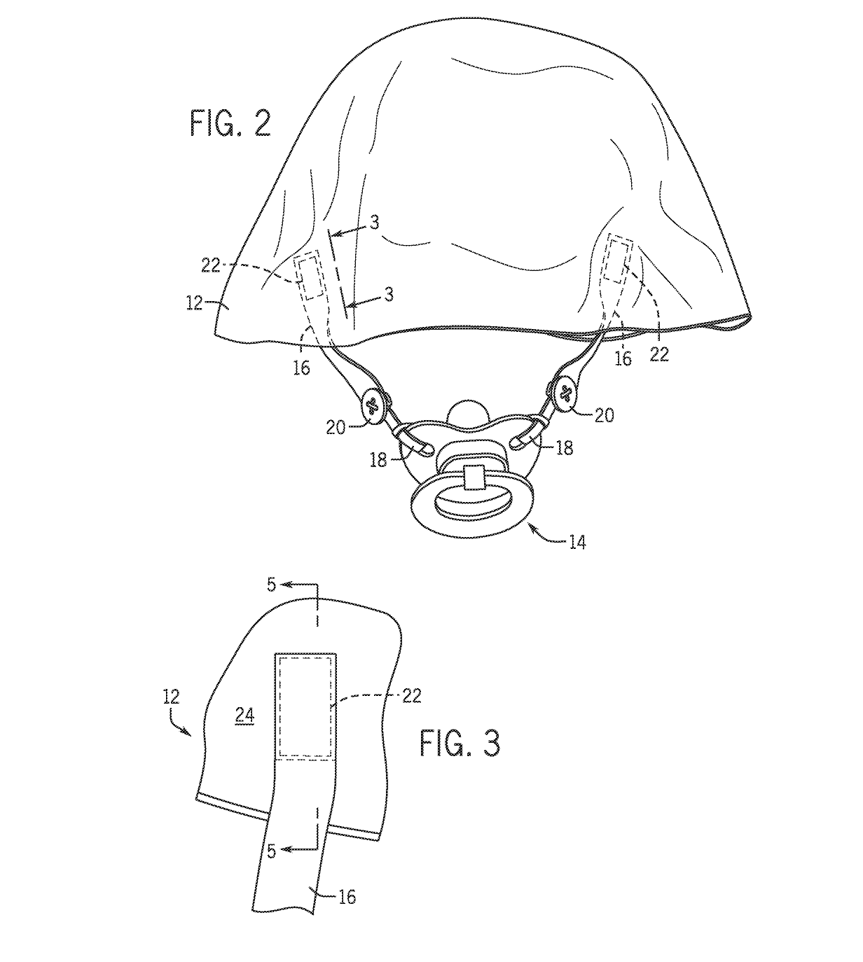

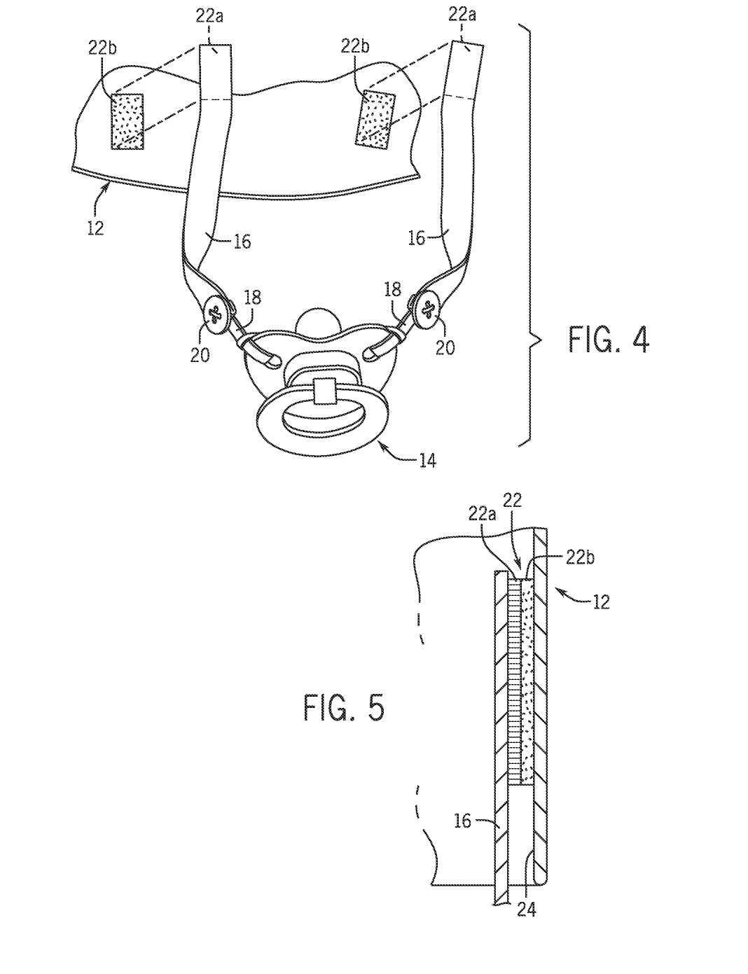

The plurality of straps 16 may be removably or permanently attached to the headwear 12 using any conventional attachment techniques. In some embodiments, the plurality of straps 16 may be attached to the headwear 12 using a hook and loop fastener 22, such as VELCRO, as shown in FIGS. 2-5. For example, as shown in FIG. 5 the hook and loop fastener 22 may have a hook component 22a and a loop component 22b. The hook component 22a may be attached to the distal end of the strap 16 and the loop component 22b may be attached to the headwear 12. In other embodiments, the plurality of straps 16 may sewn to the headwear 12, while in other embodiments the plurality of straps 16 may be attached to the headwear 12 using an adhesive, snaps, buttons, or any other suitable attachment.

In embodiments, each of the plurality of straps 16 may be attached to the headwear 12 such that each strap will be located on the opposite side of a wearer's head from the other strap. The straps may be attached to either an inner surface 24 of the headwear 12, as shown in FIGS. 1-5. Alternatively, the straps may be attached to an outer surface of the headwear 12. In other embodiments, the straps may be attached to the rim of the headwear 12.

The headwear 12 may be any type of headwear worn by a person. For example, the headwear 12 may be a baby cap, a bonnet, a baseball cap, a helmet, a headband, or any other conventional type of headwear.

The plurality of straps 16 may be made of any suitable material. In some embodiments, the straps 16 are made of an elastic material. The cord 18 may also be made of any suitable material, such as a braided cord, a ribbon, a shoestring, yarn, or any other string material. The length of the straps 16 and the cord 18 is not limited, and may vary depending on the size of the wearer's head. For example, in some embodiments, the straps 16 may each be made of a 4.5 inch long, ½ inch wide elastic, and the cord 18 may be a 5 inch long string, such as a round shoe lace or a flat cord.

When worn, for example, when the headwear 12 is placed on a baby's head, the plurality of straps 16 come down either side of the wearer's face and attach to a pacifier 14, putting slight pressure on the pacifier toward the wearer's mouth. In embodiments, the pressure is strong enough to hold the pacifier in place in the wearer's mouth, but weak enough that a wearer can spit the pacifier out, if desired.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A device for attaching a pacifier to a piece of headwear, the device comprising at least two straps attached to the headwear, each of the at least two straps having a proximal end and a distal end, wherein:
the at least two straps are spaced from each other so as to be positioned on opposite sides of a wearer's face; and
the distal end each of the at least two straps is configured to attach to a pacifier.

2. The device of claim 1, further comprising at least two cords, each cord having a distal end and a proximal end, wherein:
the distal end of each of the at least two straps is attached to the proximal end of one of the at least two cords, and
the at least two cords are configured to attach to the pacifier.

3. The device of claim 2, wherein the distal end of each of the at least two straps is sewn to the proximal end of one of the at least to cords.

4. The device of claim 2, wherein the distal end of each of the at least two cords has a loop, such that the proximal end of each of the at least two cords passes through an orifice on a mouth shield of the pacifier and then through the loop at the distal end of the cord to attach the cord to the pacifier.

5. The device of claim 2, wherein the distal end of the at least two straps is attached to the proximal end of one of the at least two cords by a fastener.

6. The device of claim 1, wherein the at least two straps are removably attached to the headwear.

7. The device of claim 6, wherein the at least two straps are attached to the headwear using a hook and loop fastener.

8. The device of claim 1, wherein the headwear is a baby cap.

9. A device for aiding a baby in holding a pacifier in its mouth, the device comprising:
a piece of headwear;
a first strap and a second strap, each strap having a proximal and a distal end, the proximal end of each of the straps being attached to the headwear such that the straps are spaced from each other; and
a pacifier,
wherein the distal end of each of the straps is removably attached to the pacifier.

10. The device of claim 9, further comprising a first cord and a second cord, each of the cords having a proximal end and a distal end, wherein:
the pacifier includes a mouth shield having a left hand side and a right hand side;
the proximal end of the first cord is attached to the distal end the first strap;
the proximal end of the second cord is attached to the distal end of the second strap;
the distal end of the first cord is attached to the left hand side of mouth shield; and
the distal end of the second cord is attached to the right hand side of the mouth shield.
